(19) United States
(12) Patent Application Publication
(10) Pub. No.: US 2015/0002555 A1
(43) Pub. Date: Jan. 1, 2015

(54) DISPLAY APPARATUS AND ASSEMBLY METHOD THEREOF FIELD OF THE INVENTION

(71) Applicant: AU OPTRONICS CORP., Hsinchu (TW)

(72) Inventors: Pei-Yi CHI, Hsin-Chu (TW); Tzu-Wei KAO, Hsin-Chu (TW); Tsang-Hsiang TSAI, Hsin-Chu (TW); Cheng-Wei LI, Hsin-Chu (TW); Chang-Lung DU, Hsin-Chu (TW)

(21) Appl. No.: 14/299,459

(22) Filed: Jun. 9, 2014

(30) Foreign Application Priority Data
Jun. 26, 2013 (TW) 102122753

(51) Int. Cl. G09G 5/10

(52) U.S. Cl. CPC G09G 5/10
USPC 345/690

(57) ABSTRACT

A display apparatus includes a display module and a backlight module. The display module includes a substrate and a display panel. The substrate includes an image region and a control region, and the control region is located at an edge of the substrate. The display panel has a first surface and a second surface opposite to the first surface. The backlight module includes a light guide plate, a circuit board, a first light source unit and a second light source unit. The circuit board has a first portion disposed on the first surface and a second portion disposed on the second surface. The first light source unit is disposed on the first portion and provides lights to an incident surface of the light guide plate. The second light source unit is disposed on the second portion and provides lights to the control region.

### FIELD OF THE INVENTION

The present invention relates to a display apparatus, and more particularly to a display apparatus applied to touch panel and an assembly method of the display apparatus.

### BACKGROUND OF THE INVENTION

Touch panel has been widely used in smart phone, tablet PC, and other electronic products. Users are capable of manipulating the electronic product by touching the touch panel or sliding fingers on the touch panel.

Generally speaking, the touch panel has a plurality of function keys, such as home key, back key, and switching function key. In order that users could manipulate the function keys in dark environment, a backlight module is usually disposed under the function keys to illuminate the function keys.

However, in manufacturing and assembly process of the electronic product, the backlight module is usually pre-manufactured at first and then adhered to a bottom surface of a display module, and then, the touch panel is assembled to the display module. This makes the assembly process to be complicated.

### SUMMARY OF THE INVENTION

The present invention provides a display apparatus with simple assembly process.

The display apparatus includes a display module and a backlight module. The display module includes a substrate and a display panel. The substrate includes an image region and a control region, and the control region is located at an edge of the substrate. The display panel has a first surface and a second surface opposite to the first surface. The backlight module includes a light guide plate, a circuit board, a first light source unit and a second light source unit. The circuit board has a first portion disposed on the first surface and a second portion disposed on the second surface. The first light source unit is disposed on the first portion and provides lights o an incident surface of the light guide plate. The second light source unit is disposed on the second portion and provides lights to the control region.

The present invention further provides an assembly method of the display apparatus, the method is of a simple process.

The method includes the following steps: providing a display panel having a first surface and a second surface opposite to the first surface; then, providing a first circuit board having a first portion and a second portion extending outwardly from an end of the first portion, wherein the first portion and the second portion are integrally formed into a single piece; then, disposing a first light source unit on the first portion and electrically connecting the first light source unit to the first portion, and disposing a second light source unit on the second portion and electrically connecting the second light source unit to the second portion; and then, disposing the first portion on the first surface and conversely bending the second portion to the second surface.

In the embodiments of the present invention, the first light source unit and the second light source unit are respectively disposed on the first portion and the second portion of the first circuit board. The first portion is disposed on the first surface of the display panel for providing lights to the display panel. The second portion is disposed on the second surface of the display panel for providing lights to the function key. Therefore, the display apparatus of the present invention has simpler structure than the conventional art, and the assembly process of the display apparatus is accordingly simplified.

### BRIEF DESCRIPTION OF THE DRAWINGS

The present invention will become more readily apparent to those ordinarily skilled in the art after reviewing the following detailed description and accompanying drawings, in which:

FIG. 1 is a schematic, cross-sectional view of a display apparatus according to a first embodiment of the present invention.

FIG. 2 is a schematic, cross-sectional view shown a control region, and a circuit board, a first light source unit and a second light source unit disposed in the control region of the display panel of FIG. 1.

FIG. 3 is a schematic, cross-sectional view shown a control region, and a circuit board, a first light source unit and a second light source unit disposed in the control region of a display panel of a second embodiment.

FIG. 4 is a schematic, exploded three-dimensional view of a display apparatus according to a third embodiment of the present invention.

FIG. 5 is a schematic, assembly view of the display apparatus of FIG. 4.

FIG. 6 is a schematic, partly cross-sectional view of the display apparatus of FIG. 5.

FIG. 7 is schematic, cross-sectional view of another part of the display apparatus of FIG. 5.

FIG. 8 is a schematic, assembly view of the display apparatus according to a fourth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

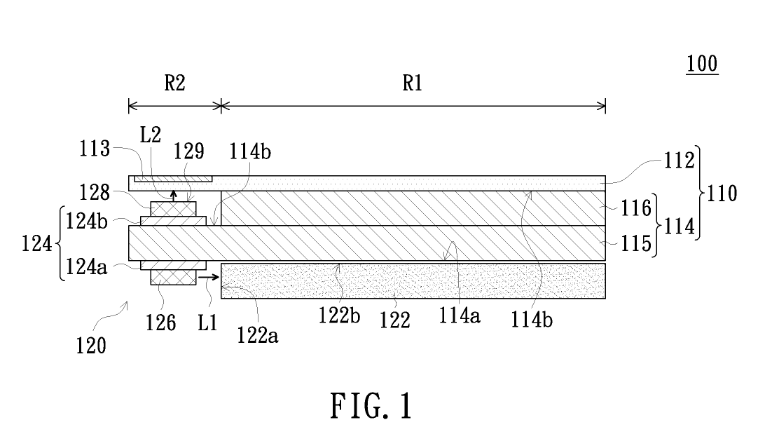

FIG. 1 is a schematic, cross-sectional view of a display apparatus according to a first embodiment of the present invention. Referring to FIG. 1, the display apparatus 100 includes a display module 110 and a backlight module 120. The display module 110 includes a substrate 112 and a display panel 114. The substrate 112 includes an image region R1 and a control region R2, and the control region R2 is located at an edge of the substrate 112. The display panel 114 has a first surface 114a and a second surface 114b opposite to the first surface 114a. The backlight module 120 includes a light guide plate 122, a circuit board 124, a first light source unit 126 and a second light source unit 128. The circuit board 124 has a first portion 124a disposed on the first surface 114a and a second portion 124b disposed on the second surface 114b. The first light source unit 126 is disposed on the first portion 124a and provides lights L1 to an incident surface 122a of the light guide plate 122. The second light source unit 128 is disposed on the second portion 124b and provides lights L2 to the control region R2.

In this embodiment, the display panel 114 is a non-self-luminous display panel. The display panel 114 includes but is not limited to liquid crystal display panel. The display panel 114 for example includes a first substrate 115, a second substrate 116 disposed on the first substrate 115, and a liquid crystal layer (not shown) disposed between the first substrate 115 and the second substrate 116. The first substrate 115 is not completely covered by the second substrate 116 and has an exposed portion exposed outside the second substrate 116. In this embodiment, the first surface 114a and the second surface 114b are two opposite surfaces of the display panel 114. The second surface 114b includes a top surface of the second substrate 116, and a top surface of the exposed portion of the first substrate 115. The second portion 124b of the circuit board 124 is disposed on the second surface 114b and located on the exposed portion of the first substrate 115. The first portion 124a of the circuit board 124 corresponds to the second portion 124b of the circuit board 124 and locates below the second portion 124b. The substrate 112 may be a protective board (such as a glass board or a transparent plastic board), or a touch panel. The image region R1 of the substrate 112 locates above a display region of the display panel 114 with an orthographic projection of the image region R1 on the display panel 114 overlaps the display region, and users could see images displayed on the display panel 114 through the image region R1 of the substrate 112. The control region R2 for example corresponds to a non-display region of the display panel 114 with an orthographic projection of the control region R2 on the display panel 114 overlaps the non-display region. The control region R2 is a region for users to manipulate the display apparatus 100. The control region R2 for example includes at least a function key 113 for users to manipulate, and FIG. 1 merely shows only one of the function keys 113. The second light source unit 128 is disposed between the control region R2 and the second surface 114b. A light emitting surface 129 of the second light source unit 128 faces to and overlaps the orthographic projection of the control region R2 for illuminating the function key 113. In this embodiment, the second light source unit 128 may include one or more second light emitting components, such as light emitting diodes, for emitting lights L2.

The incident surface 122a of the light guide plate 122 is located at a lateral side of the light guide plate 122, and the first light source unit 126 is disposed adjacent to the incident surface 122a. The first light source unit 126 for example includes a plurality of first light emitting components for emitting lights L1. The light guide plate 122 transforms the lights L1 to a plane light after the lights L1 entering into the light guide plate 122 through the incident surface 122a. Then, the lights leave the light guide plate 122 from a light exiting surface 122b and enter into the display panel 114. The display panel 114 is disposed above the light exiting surface 122b to receive lights from the plane light source. Furthermore, at least an optical film, such as a brightness enhancement film, and/or a diffuser film, can be disposed between the light exiting surface 122b and the display panel 114.

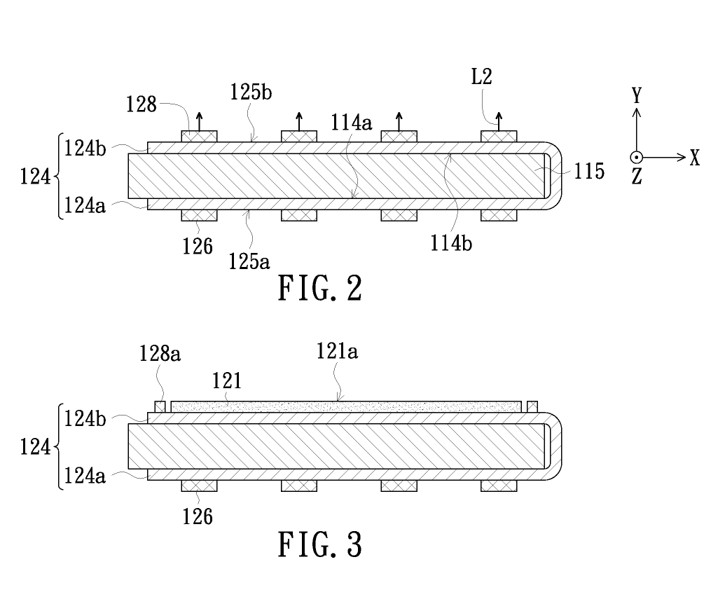

FIG. 2 is a schematic, cross-sectional view shown the control region, and the circuit board, the first light source unit and the second light source unit disposed in the control region of the display panel of FIG. 1. Referring to FIG. 2, the first light source unit 126 emits light along Z-axis, and the second light source unit 128 emits light along Y-axis. Referring to FIGS. 1 and 2, the circuit board 124 may be a flexible circuit board, and the circuit board 124 is bent to U-shaped and extends from the first surface 114a to the second surface 114b of the first substrate 115. The second portion 124b of the circuit board 124 has an arrangement surface 125b for arranging the second light source unit 128, and the first portion 124a has an arrangement surface 125a for arranging the first light source unit 126. The arrangement surfaces 125a and 125b are formed by bending one surface of the circuit board 124. The second portion 124b conversely extends from a distal end of the first portion 124a and is disposed on the second surface 114b. The arrangement surface 125a of the first portion 124a and the arrangement surface 125b of the second portion 124b are located at two opposite sides of the bent circuit board 124.

In this embodiment of the present invention, the first light source unit 126 and the second light source unit 128 are respectively disposed on the first portion 124a and the second portion 124b of the circuit board 124, the first portion 124a is disposed on the first surface 114a of the display panel 114 for providing lights L1 toward the light guide plate 122 and further providing plane light source for the display panel 114, the second portion 124b is disposed on the second surface 114b of the display panel 114 for providing lights L2 toward the control region R2 to illuminate the function key 113. As compared to the conventional art, this embodiment integrates the first light source unit 126 for providing lights L1 toward the light guide plate 112 together with the second light source unit 128 for providing lights L2 toward the control region R2 into a single circuit board 124. This not only simplifies the structure and decreases the cost of the display apparatus 100, but also simplifies the assembly process and accordingly increases assembly efficiency of the display apparatus 100.

In this embodiment, an orthographic projection of the second light source unit 128 on the first portion 124a of the circuit board 124 overlaps the first light source unit 126 on the first portion 124a of the circuit board 124. That is to say, the second light emitting components of the second light source unit 128 are disposed right above the first light emitting components of the first light source unit 126. Alternatively, in another embodiment, the orthographic projection of the second light source unit 128 on the first portion 124a of the circuit board may be non-overlap with the first light source unit 126. For example, the second light emitting components of the second light source unit 128 may align with gaps formed between the first light emitting components of the first light source unit 126. That is to say, the first light source unit 126 are alternately arranged with the orthographic projection of the second light source unit 128 on the first portion 124a. By means of this arrangement, wirings of the first light emitting components of the first light source unit 126 could be arranged at positions corresponding to orthographic projections of the second light emitting components of the second light source unit 128 on the first portion 124a of the circuit board 124, and wirings of the second light emitting components of the second light source unit 128 could be arranged at positions corresponding to orthographic projections of the first light emitting components of the first light source unit 126 on the second portion 124b of the circuit board 24. This arrangement efficiently utilizes wiring area of the circuit board 124 and decreases distances between the light emitting components of the first light source unit 126 or the second light source unit 128, and further increases a capable arrangement number of the light emitting components of the first light source unit 126 or the second light source unit 128, and therefore reaches the requirement of improving whole brightness of the display apparatus 100.

FIG. 3 is a schematic, cross-sectional view shown a control region, and a circuit board, a first light source unit and a second light source unit disposed in the control region of a display panel of a second embodiment of the present invention. In this embodiment, the second light emitting components of the second light source unit 128a are disposed at opposite ends of the second portion 124b of the circuit board 124, and the orthographic projections of the second light emitting components on the first portion 124a are non-overlap with the first light emitting components of the first light source unit 126. The first light emitting components for example align with gaps formed between the second light emitting components of the second light source unit 128a. Furthermore, the backlight module further includes a light guide bar 121 disposed between the second light emitting components of the second light source unit 128a. That is to say, the orthographic projection of the light guide bar 121 on the first portion 124a overlaps—the first light emitting components of the first light source unit 126. A light exiting surface 121a of the light guide bar 121 faces to the control region R2 shown in FIG. 1, for guiding lights provided by the second light source unit 128a toward the control region R2. In this embodiment, by means of utilizing the light guide bar 121, the number of the second light emitting components of the second light source unit 128a could be reduced, therefore, the cost of the display apparatus 100 could be reduced and electrical energy could be saved.

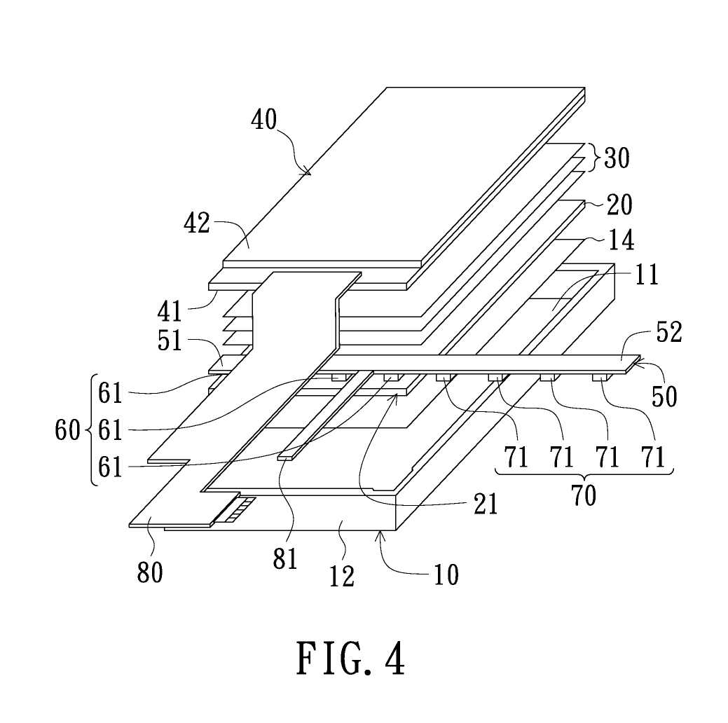

FIG. 4 is a schematic, exploded three-dimensional view of a display apparatus according to a third embodiment of the present invention. Referring to FIG. 4, the display apparatus includes a back plate 10, a reflector board 14, a light guide plate 20, a plurality of optical films 30, a display panel 40, a first circuit board 50, and a first light source unit 60 and a second light source unit 70 disposed on the first circuit board 50.

The back plate 10 has a bottom wall 11 and a sidewall 12 upwardly extending from a periphery edge of the bottom wall 11. An accommodating space 13 is defined between the bottom wall 11 and the sidewall 12. The reflector board 14, the light guide plate 20, the optical films 30 and the display panel 40 are disposed in the accommodating space 13 in that order. The light guide plate 20 is disposed between the back plate 10 and the display panel 40. The optical films 30 are disposed between the light guide plate 20 and the display panel 40. The reflector board 14 is disposed between the bottom wall 11 of the back plate 10 and the light guide plate 20, and is disposed under the light guide plate 20 at a side remote from the optical films 30. More concretely, the optical films 30 may be but not limited to brightness enhancement film, or diffuser film.

The display panel 40 has a first surface 41 and a second surface 42 opposite to the first surface 42. The first surface 41 faces to the optical films 30, and the second surface 42 opposite to the optical films 30. In this embodiment, the display panel 40 may be but not limited to liquid crystal display panel, which has two substrates stacked together and a liquid crystal display layer disposed between the substrates.

The first circuit board 50 may be a strip-like flexible circuit board, and includes a first portion 51 and a second portion 52 having substantially the same length as the first portion 51. The first portion 51 is located under the display panel 40, and the second portion 52 extends outwardly from an end of the first portion 51. The first light source unit 60 includes a plurality of first light emitting components 61. The first light emitting components 61 are disposed on the first portion 51 with spaces formed between adjacent components. The first light emitting components 61 are electrically connected to the first portion 51, for providing lights to the incident surface to the light guide plate 20. The second light source unit 70 includes a plurality of second light emitting components 71. The second light emitting components 71 are disposed on the second portion 52 with spaces formed between adjacent components. The second light emitting components 71 are electrically connected to the second portion 52, for providing lights to the function keys of the touch panel.

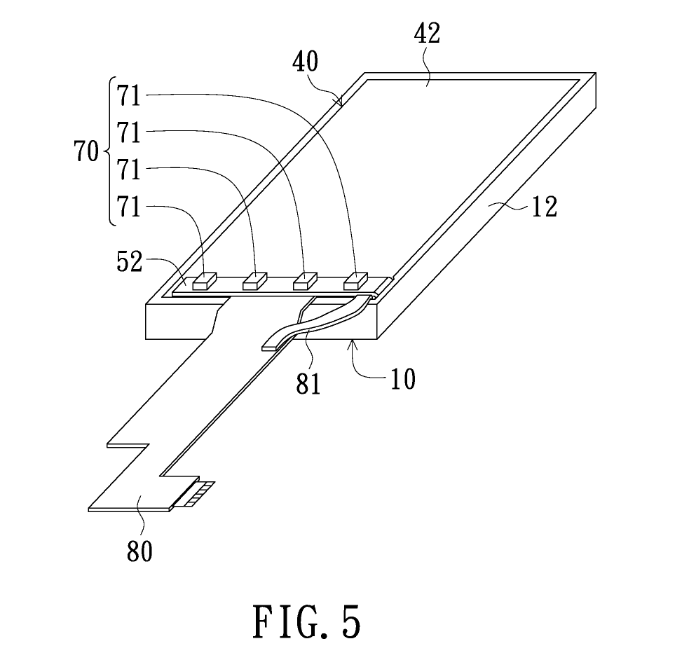

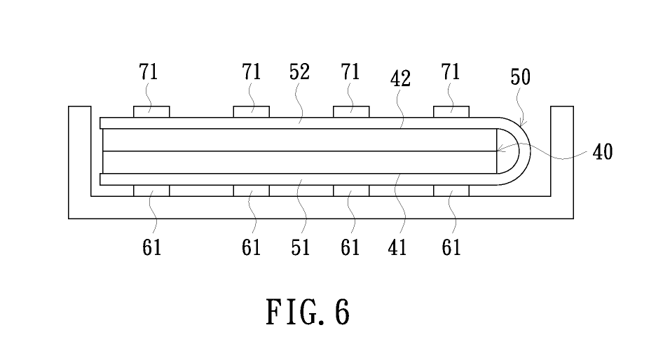

FIG. 5 is a schematic, assembly view of the display apparatus of FIG. 4. FIG. 6 is a schematic, partly cross-sectional view of the display apparatus of FIG. 5. Referring to FIGS. 5 and 6, after the display apparatus is assembled, the first portion 51 of the first circuit board 50 is disposed on the first surface 41 of the display panel 40, and the second portion 52 of the first circuit board 50 conversely extends from an end of the first portion 51 and is disposed on the second surface 42 of the display panel 40.

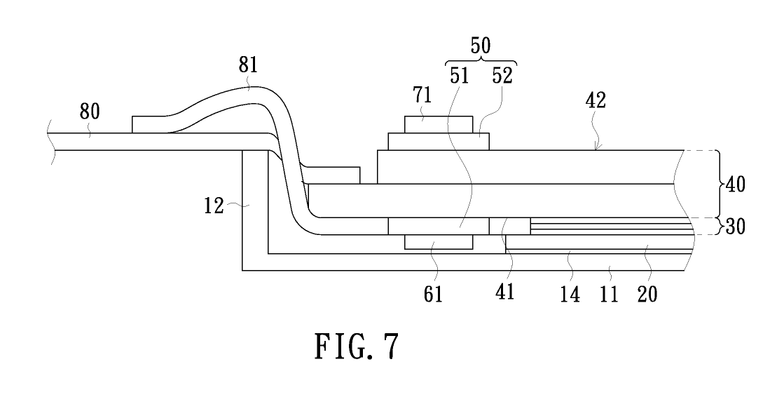

FIG. 7 is schematic, cross-sectional view of another part of the display apparatus of FIG. 5. Referring to FIGS. 5 and 7, the display apparatus further includes a second circuit board 80 and a first wire 81. The second circuit board 80 is electrically connected to the display panel 40 for providing electrical signals to drive the display panel 40. The first wire 81 electrically connects the first portion 51 of the first circuit board 50 to the second electrical board 80. Accordingly, the first light emitting components 61 of the first light source unit 60 and the second light emitting components 71 of the second light source unit 70 are electrically connected to the second circuit board 80. Therefore, the second circuit board 80 could also provides electrical power to the first light emitting components 61 of the first light source unit 60 and the second light emitting components 71 of the second light source unit 70 while providing electrical signals to the display panel 40. In this embodiment, the second circuit board 80 and the first wire 81 may be but not limited to flexible circuit board.

In the present invention, the first light source unit 60 and the second light source unit 70 are respectively disposed on the integrally formed portions of the first circuit board 50, i.e., the first portion 51 and the second portion 52 of the first circuit board 50, and the first portion 51 is disposed on the first surface 41 of the display panel 40. Therefore, the first light source unit 60 is capable of providing lights to the light guide plate 20 and functioning as light source of the backlight module. The second portion 52 is conversely bent and adhered to the second surface 40 of the display panel 42, and the second light source unit 70 is therefore capable of providing lights to the function keys of the touch panel and functioning as light source of the function keys. As compare to the conventional art, the present invention effectively simplifies the assembly process of the display apparatus.

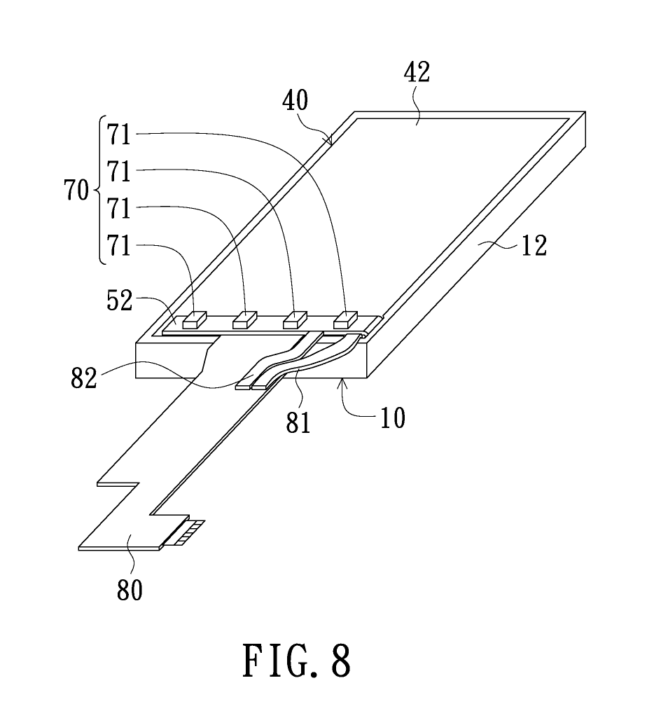

FIG. 8 is a schematic, assembly view of the display apparatus according to a fourth embodiment of the present invention. The display apparatus of the fourth embodiment is substantially the same as the third embodiment. The difference is, the first light source unit 60 and the second light source unit 70 of the fourth embodiment are respectively and electrically connected to the second circuit board 80 by a first wire 81 and a second wire 82. The second circuit board 80 could provide electrical power to the first light emitting components 61 of the first light source unit 60 and the second light emitting components 71 of the second light source unit 70 by the first wire 81 or the second wire 82. Therefore, the second circuit board 80 could still provide electrical power to the first light emitting components 61 of the first light source unit 60 and the second light emitting components 71 of the second light source unit 70 if one of the first wire 81 and the second wire 82 is broken.

Referring to FIGS. 4 and 5, an assembly method of the display apparatus includes the following steps:

First of all, a display panel 40 is provided. The display panel 40 has a first surface 41 and a second surface 42 opposite to the first surface 41. Next, a first circuit board 50 is provided, a first light source unit 60 is disposed on a first portion 51 of the first circuit board 60 and electrically connects to the first portion 51, and a second light source unit 70 is disposed on a second portion 52 of the first circuit board 50 and electrically connects to the second portion 52. Then, the first portion 51 of the first circuit board 50 is disposed on the first surface 41 of the display panel 40. Furthermore, a second circuit board 80 is electrically connected to the display panel 40, and the first portion 51 of the first circuit board 50 is electrically connected to the second circuit board 80 by the first wire 81.

Then, the display panel 40 is assembled to the accommodating space 13 of the back plate 10 with a reflector board 14, a light guide plate 20 and a plurality of optical films 30 disposed therein. In the accommodating space 13, the light guide plate 20 is disposed at the first surface side of the display panel 40. The optical films 30 are disposed between the light guide plate 20 and the display panel 40. The reflector board 14 is disposed below the light guide plate 20 at an edge remote from the optical film 30. The light guide plate 20 has an incident surface facing to the first light emitting components 61 of the first light source unit. Lights emitted from the first light emitting components enter into the light guide plate through the incident surface.

Then, the second portion 52 of the first circuit board 50 is conversely bent and adhered to the second surface 42 of the display panel 40, and the display apparatus of the present invention is accordingly obtained. Furthermore, in the embodiment shown in FIG. 8, the assembly method further includes the step of electrically connecting the second portion 52 of the first circuit board 50 to the second circuit board 80 by the second wire 82 and accordingly obtaining the display apparatus.

It should be mentioned that the function keys in the forgoing embodiments of the present invention may be but not limited to actual press keys or decorative patterns formed on the touch panel.

For the forgoing descriptions, in the embodiments of the present invention, the first light source unit and the second light source unit are respectively disposed on the first portion and the second portion of the first circuit board. The first portion is disposed on the first surface of the display panel for providing lights to the display panel. The second portion is disposed on the second surface of the display panel for providing lights to the function key. Therefore, the display apparatus of the present invention has simpler structure than the conventional art, and the assembly process of the display apparatus is accordingly simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus comprising:
a display module comprising:
a substrate having an image region and a control region, and the control region being located at an edge of the substrate; and
a display panel disposed below the substrate and having a first surface and a second surface opposite to the first surface, and further having a display region and a non-display region, an orthographic projection of the image region on the display panel overlapping the display region, and an orthographic projection of the control region on the display panel overlapping the non-display region; and
a backlight module comprising:
a light guide plate located at a side of the display panel corresponding to the first surface, the light guide plate having an incident surface and a light exiting surface, the light exiting surface being disposed adjacent to the incident surface and corresponding to the image region;
a circuit board having a first portion disposed on the first surface and a second portion disposed on the second surface and conversely extending from an end of the first portion;
a first light source unit disposed on the first portion and electrically connected to the first portion, and for providing lights to the incident surface of the light guide plate; and
a second light source unit disposed on the second portion and electrically connected to the second portion, and the second light source unit having a light emitting surface overlapping an orthographic projection of the control region for providing lights to the control region.

2. The display apparatus according to claim 1, wherein the first portion has a first arrangement surface for arranging the first light source unit, the second portion has a second arrangement surface for arranging the second light source unit, the first arrangement surface and the second arrangement surface are formed from bending a surface of the circuit board.

3. The display apparatus according to claim 1, wherein the first portion has a first arrangement surface for arranging the first light source unit, the second portion has a second arrangement surface for arranging the second light source unit, the first arrangement surface and the second arrangement surface are disposed at two opposite surfaces of the circuit board.

4. The display apparatus according to claim 1, wherein the incident surface of the light guide plate is disposed at one side of the light guide plate and the first light source unit is disposed adjacent to the incident surface.

5. The display apparatus according to claim 1, wherein an orthographic projection of the second light source unit on the first portion of the circuit board is non-overlap with the first light source unit.

6. The display apparatus according to claim 1, wherein the first light source unit comprises a plurality of first light emitting components, and the second light source unit comprises a plurality of second light emitting components, the second light emitting components of the second light source unit are disposed at opposite ends of the second portion of the circuit board and the orthographic projections of the second light emitting components on the first portion are non-overlap with the first light emitting components of the first light source unit.

7. The display apparatus according to claim 6, wherein the backlight module further comprises a light guide bar disposed between the second light emitting components of the second light source unit, and a light exiting surface of the light guide bar faces to the control region.

8. The display apparatus according to claim 7, wherein the orthographic projection of the light guide bar overlaps the first light emitting components of the first light source unit.

9. The display apparatus according to claim 1, wherein the substrate is a touch panel or a protective board.

10. The display apparatus according to claim 1, wherein the control region comprises at least a function key.

11. An assembly method of a display apparatus, comprising:
providing a display panel having a first surface and a second surface opposite to the first surface;
providing a first circuit board having a first portion and a second portion extending outwardly from an end of the first portion, wherein the first portion and the second portion are integrally formed into a single piece;
disposing a first light source unit on the first portion and electrically connecting the first light source unit to the first portion, and disposing a second light source unit on the second portion and electrically connecting the second light source unit to the second portion;
disposing the first portion on the first surface and conversely bending the second portion to the second surface.

12. The assembly method according to claim 11, wherein before the step of conversely bending the second portion to the second surface, the assembly method further comprising:
attaching the display panel to a backlight module.

13. The assembly method according to claim 11, wherein the assembly method further comprising:
electrically connecting a second circuit board to the display panel; and
electrically connecting the first portion to the second circuit board by a first wire.

14. The assembly method according to claim 13, wherein after the step of conversely bending the second portion to the second surface, the assembly method further comprising:
electrically connecting the second portion to the second circuit board by a second wire.

15. The assembly method according to claim 11, wherein the assembly method further comprising:
disposing a light guide plate on the first surface of the display panel, the light guide plate having an incident surface facing to the first light source unit for introducing lights emitted by the first light source unit into the light guide plate.
